(19) United States
(12) Patent Application Publication
(10) Pub. No.: US 2026/0233622 A1
(43) Pub. Date: Aug. 13, 2026

(54) CONTROLLER FOR VEHICLE

(71) Applicant: TOYOTA JIDOSHA KABUSHIKI KAISHA, Toyota-shi (JP)

(72) Inventor: Yoshinori OGAMI, Nisshin-shi (JP)

(21) Appl. No.: 19/385,160

(22) Filed: Nov. 11, 2025

(30) Foreign Application Priority Data
Feb. 13, 2025 (JP) 2025-021687

(51) Int. Cl. B60L 50/61; B60L 7/16

(52) U.S. Cl. CPC B60L 50/61; B60L 7/16; B60L 2240/545; B60L 2250/28

(57) ABSTRACT

A battery transmits and receives power to and from a first motor generator and a second motor generator of a vehicle. A value of an allowable charging power of the battery is changed to a smaller value as a battery temperature of the battery is lower. Processing circuitry controls a charging power of the battery such that the charging power does not exceed the allowable charging power. When an accelerator of the vehicle is off, a regenerative braking force is generated in the second motor generator. The processing circuitry adjusts the regenerative braking force such that the regenerative braking force applied when the battery temperature is relatively low is smaller than the regenerative braking force applied when the battery temperature is relatively high.

### CROSS-REFERENCE TO RELATED APPLICATIONS

The present application claims priority to Japanese Patent Application No. 2025-021687 filed on February 13, 2025, the disclosure of which is incorporated herein by reference in its entirety.

### BACKGROUND

### Field

The present disclosure relates to a controller for a vehicle.

### Description of Related Art

JP2014-189102A discloses an example of a hybrid electric vehicle that includes an internal combustion engine, a planetary gear mechanism, a battery, and a controller. The planetary gear mechanism includes a carrier that holds a sun gear, a ring gear, and a pinion gear. A first motor generator is connected to the sun gear. A crankshaft of the internal combustion engine is connected to the carrier. A second motor generator and drive wheels are connected to the ring gear. The battery transmits and receives power to and from the first motor generator and the second motor generator.

In a hybrid electric vehicle equipped with the planetary gear mechanism, the operation of the internal combustion engine is stopped when the accelerator is off. Then, a regenerative braking force, which is a braking force generated by regeneration, is generated in the second motor generator.

Therefore, when the accelerator is off, power generated by the second motor generator is supplied to the battery, so that the battery is charged.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

The present disclosure provides a controller for a vehicle. The controller including processing circuitry. The processing circuitry is configured to control a charging power of a battery of the vehicle. The battery is configured to transmit and receive power to and from a first motor generator and a second motor generator of the vehicle, The planetary gear mechanism includes a sun gear, a ring gear, and a carrier. The first motor generator is connected to the sun gear of the planetary gear mechanism. A crankshaft of an internal combustion engine of the vehicle is connected to the carrier. The second motor generator is connected to the ring gear. A drive wheel of the vehicle is connected to the ring gear. The battery has an allowable charging power. A value of the allowable charging power is changed to a smaller value as a battery temperature of the battery is lower. The processing circuitry controls the charging power of the battery such that the charging power does not exceed the allowable charging power. When an accelerator of the vehicle is off, a regenerative braking force is generated in the second motor generator. The processing circuitry adjusts the regenerative braking force. The processing circuitry adjusts the regenerative braking force such that the regenerative braking force applied when the battery temperature is relatively low is smaller than the regenerative braking force applied when the battery temperature is relatively high.

Another aspect of the present disclosure provides a vehicle including the same controller.

The controller for the vehicle is capable of limiting the start of the internal combustion engine when the temperature of the battery is relatively low.

If the charging power as the power supplied to the battery is excessively large, deterioration of the battery may progress. The allowable charging power is an upper limit value of the charging power that is set to limit deterioration of the battery. The allowable charging power decreases as the temperature of the battery decreases. Thus, the allowable charging power is changed to a smaller value as the temperature of the battery is lower. The charging power of the battery is controlled so as not to exceed the allowable charging power.

When the temperature of the battery is relatively low, the allowable charging power is relatively small. Accordingly, the charging power of the battery may be greater than the allowable charging power. To solve this problem, in a case in which there is a possibility that the charging power of the battery is greater than the allowable charging power when the accelerator of the hybrid electric vehicle including the planetary gear mechanism is off, for example, the internal combustion engine may be started by driving the first motor generator. However, the driver of the hybrid electric vehicle tends to expect that the operation of the internal combustion engine will be minimized. Accordingly, if the internal combustion engine is intentionally started when the operation of the internal combustion engine is stopped by the accelerator-off, the driver may feel a sense of discomfort. Thus, it is desirable to minimize the start of the internal combustion engine when the battery temperature is relatively low. The above-configuration contributes to this.

Other features and aspects will be apparent from the following detailed description, the drawings, and the claims.

### BRIEF DESCRIPTION OF THE DRAWINGS

FIG. 1 is a schematic diagram illustrating a configuration of a vehicle according to an embodiment.

FIG. 2 is a flowchart illustrating a procedure of processes executed by the processing circuitry in the embodiment.

FIG. 3 is a graph showing the relationship between the battery temperature and the magnitude of the regenerative braking force in the embodiment.

FIG. 4A is a timing diagram illustrating changes in the battery temperature to show the operation of the embodiment.

FIG. 4B is a timing diagram illustrating changes in the accelerator operation amount.

FIG. 4C is a timing diagram illustrating changes in the regeneration mode.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

Hereinafter, an embodiment of a controller for a vehicle will be described.

### Configuration of Vehicle

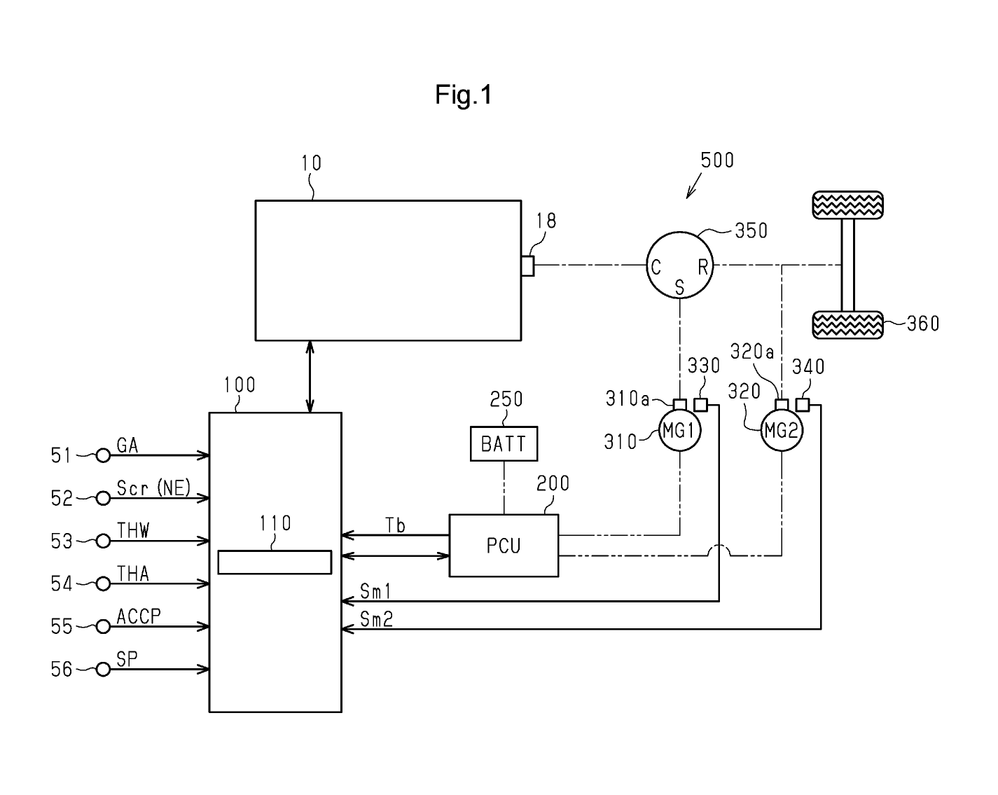

As shown in FIG. 1, a vehicle 500 is equipped with an internal combustion engine 10 as a power source and an electric motor.

A crankshaft 18 of the internal combustion engine 10 is mechanically connected to a carrier C of a planetary gear mechanism 350 of a power split mechanism. The carrier C holds rotation shafts of a plurality of pinion gears included in the planetary gear mechanism 350.

A rotation shaft 310a of a first motor generator (hereinafter referred to as a first MG) 310 is mechanically connected to a sun gear S of the planetary gear mechanism 350.

A rotation shaft 320a of a second motor generator (hereinafter referred to as a second MG) 320 and drive wheels 360 are mechanically connected to a ring gear R of the planetary gear mechanism 350.

The first MG 310 functions as a power generator that generates power using engine power. When the internal combustion engine 10 is started, the first MG 310 functions as a starter for cranking the crankshaft 18.

The second MG 320 functions as a motor that generates a driving force of the drive wheel 360. The second MG 320 functions as a power generator that generates power by regeneration during deceleration of the vehicle 500. When the second MG 320 generates power through regeneration, a regenerative braking force, which is a braking force produce through regeneration, is generated in the second MG 320.

The first MG 310 and the second MG 320 transmit and receive power to and from the battery 250 via a power control unit (PCU) 200. That is, the battery 250 is configured to transmit and receive power to and from the first MG 310 and the second MG 320. The battery 250 is charged by using the output of the internal combustion engine 10, and supplies power to the first MG 310 and the second MG 320. The PCU 200 includes, for example, a converter and an inverter. The converter is configured to increase direct current voltage received from the battery 250 and output the voltage. The inverter converts the direct current voltage of the converter into alternating current voltage and outputs the alternating current voltage to each of the MGs 310 and 320.

### Controller

The controller 100 controls the output and exhaust gas properties of the internal combustion engine 10 by controlling an intake air amount, a fuel injection amount, and an ignition timing. The controller 100 operates an inverter via the PCU 200 to control the torque of the first PCU 310. The controller 100 operates the inverter via the PCU 200 320 to control the torque of the second PCU 320. The magnitude of the regenerative braking force of the second PCU 320 is changed by the operation of the inverters via the PCU 200. As the power generated by the second MG 320 increases, the regenerative braking force of the second MG 320 increases. Then, the deceleration of the vehicle 500 due to the regenerative braking force increases.

The controller 100 includes processing circuitry 110. The processing circuitry 110 includes a CPU that executes various processes in accordance with a program and a ROM in which various programs are stored.

The controller 100 refers to detection values of various sensors. For example, the controller 100 refers to a detection value of an air flow meter 51. The air flow meter 51 detects an intake air amount GA of the internal combustion engine 10. The controller 100 refers to a detection signal Scr of a crank angle sensor 52. The crank angle sensor 52 detects a rotation angle of the crankshaft 18. The controller 100 refers to a detection value of a water temperature sensor 53 that detects a coolant temperature THW. The coolant temperature THW is the temperature of the coolant in the internal combustion engine 10. The controller 100 refers to a detection value of an intake air temperature sensor 54 that detects an intake air temperature THA. The intake air temperature THA is the temperature of intake air in the internal combustion engine 10. The controller 100 refers to a detection signal of an accelerator position sensor 55 that detects an accelerator operation amount ACCP. The accelerator operation amount ACCP is an operation amount of an accelerator pedal operated by a driver of the vehicle 500. The controller 100 refers to a detection signal of a speed sensor 56 that detects a vehicle speed SP of the vehicle 500. The controller 100 refers to an output signal Sm1 output from the first rotation angle sensor 330 and an output signal Sm2 output from the second rotation angle sensor 340. The first rotation angle sensor 330 detects a rotation angle of the first MG 310. The second rotation angle sensor 340 detects a rotation angle of the second MG 320. The controller 100 acquires a battery temperature Tb, which is the temperature of the battery 250, from the PCU 200.

The controller 100 calculates an engine speed NE based on the detection signal Scr of the crank angle sensor 52. Further, the controller 100 calculates an engine load factor KL based on the engine rotation speed NE and the intake air amount GA. The engine load factor KL represents the ratio of the current cylinder inflow air amount to the cylinder inflow air amount when the internal combustion engine 10 is steadily operated in a full load state at the current engine rotation speed NE. The cylinder inflow air amount is the amount of air that flows into each cylinder in the intake stroke.

Further, the controller 100 calculates a requested torque necessary for traveling of the vehicle based on the accelerator operation amount ACCP and the vehicle speed SP. The controller 100 controls an engine requested output Pe of the internal combustion engine 10 and output torques of the first motor generator 310 and the second motor generator 320 to satisfy the requested torque of the vehicle. For example, when the requested engine output Pe of the internal combustion engine 10 is 0, the controller 100 stops the operation of the internal combustion engine 10 and performs EV traveling. In the EV traveling, the vehicle travels using the output torque of the second motor generator 320. When the engine required output Pe of the internal combustion engine 10 is larger than 0, the controller 100 operates the internal combustion engine 10 to obtain the engine output, and performs hybrid traveling. In the hybrid traveling, the vehicle travels using the engine output and the output torque of the second motor generator 320.

When the accelerator is turned off, the accelerator operation amount ACCP becomes 0. The controller 100 adjusts charging power by controlling the regenerative braking force generated by the second MG 320 when the accelerator is off. The charging power is supplied from the second MG 320 to the battery 250.

The controller 100 variably sets an allowable charging power Win to be smaller as the battery temperature Tb is lower. The allowable charging power Win is an upper limit value of the charging power when the battery 250 is charged. The controller 100 controls the charging power of the battery 250 such that the charging power of the battery 250 does not exceed the allowable charging power Win. Hereinafter, a process that adjusts the regenerative braking force related to the charging power will be described.

### Adjustment of Regenerative Braking Force

The processing circuitry 110 executes a process that adjusts the regenerative braking force generated in the second MG 320 when the accelerator is off in the vehicle 500. Specifically, the regenerative braking force is adjusted such that the regenerative braking force is smaller when the battery temperature Tb is relatively low than when the battery temperature Tb is relatively high.

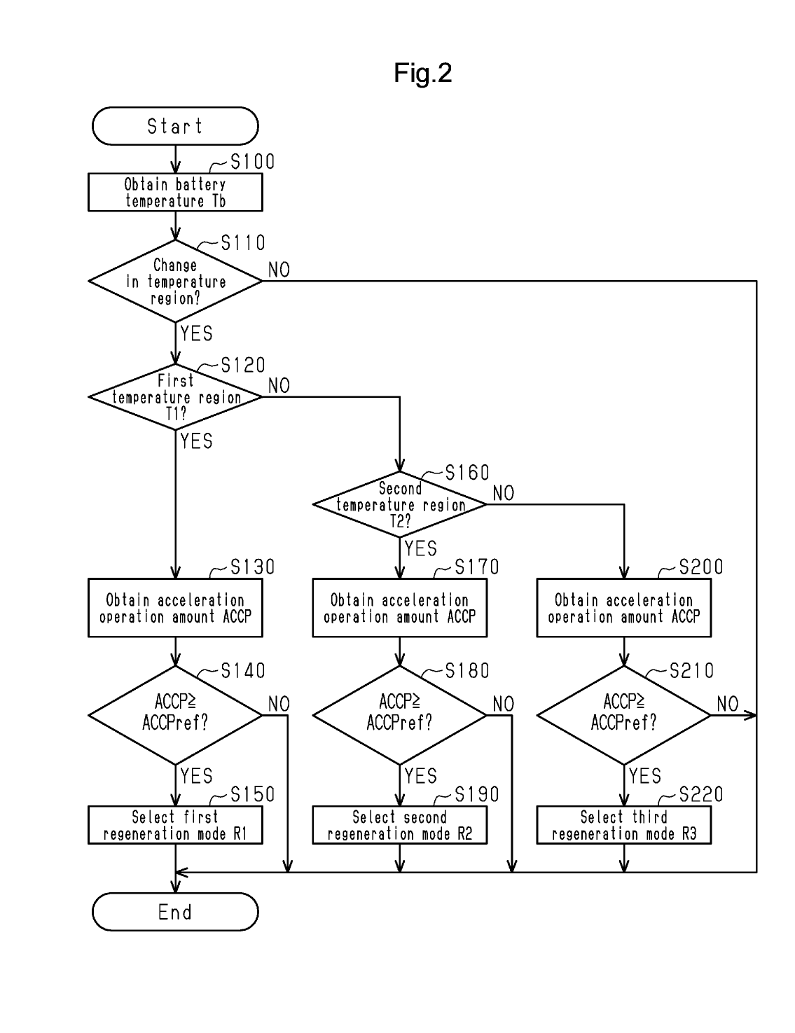

FIG. 2 shows a procedure for processes for adjusting the regenerative braking force. These processes are executed by the processing circuitry 110 of the controller 100 in each predetermined execution cycle. In the following description, the number of each step is represented by the letter S followed by a numeral.

In the series of processes shown in FIG. 2, the processing circuitry 110 first acquires the battery temperature Tb (S100).

Next, the processing circuitry 110 determines whether a change has occurred in the temperature region to which the acquired battery temperature Tb belongs (S110). In the present embodiment, a plurality of temperature regions are set for the battery temperature Tb. For example, in the present embodiment, a first temperature region T1, a second temperature region T2, and a third temperature region T3 are set. The first temperature region T1 is greater than or equal to a first preset value A. The third temperature region T3 is less than or equal to a second preset value B set to a temperature lower than the first preset value A. The second temperature region T2 has a temperature higher than the second preset value B and lower than the first preset value A. Therefore, the second temperature region T2 is higher than the third temperature region T3. The first temperature region T1 is higher than the second temperature region T2. That is, when they are arranged in descending order of temperature, third temperature region T3 < second preset value B < second temperature region T2 < first preset value A < first temperature region T1.

In the process of S110, when the temperature region to which the battery temperature Tb obtained in the previous execution of the present process belonged is different from the temperature region to which the battery temperature Tb obtained in the current execution of the present process belongs, the processing circuitry 110 determines that a change has occurred in the temperature region to which the battery temperature Tb belongs. In contrast, when the temperature region to which the battery temperature Tb obtained in the previous execution of the present process belongs is equal to the temperature region to which the battery temperature Tb obtained in the current execution of the present process belongs, the processing circuitry 110 determines that no change has occurred in the acquired temperature region to which the battery temperature Tb belongs.

In the process of S110, when determining that a change has occurred in the temperature region to which the acquired battery temperature Tb belongs, the processing circuitry 110 determines whether the temperature region to which the acquired battery temperature Tb belongs is the first temperature region T1 (S120). When determining that the temperature region is the first temperature region T1 (S120: YES), the processing circuitry 110 acquires the current accelerator operation amount ACCP (S130).

After executing the process of S130, the processing circuitry 110 determines whether the acquired accelerator operation amount ACCP is greater than or equal to an accelerator determination value ACCPref (S140). The magnitude of the accelerator determination value ACCPref is set in advance such that it is possible to accurately determine that the driver of the vehicle 500 has depressed the accelerator pedal based on the accelerator operation amount ACCP being greater than or equal to the accelerator determination value ACCPref.

In the process of S140, when determining that the accelerator operation amount ACCP is greater than or equal to the accelerator determination value ACCPref (S140: YES), the processing circuitry 110 selects a first regeneration mode R1 as the regeneration mode for setting the regenerative braking force of the second MG 320 at the time of accelerator-off (S150).

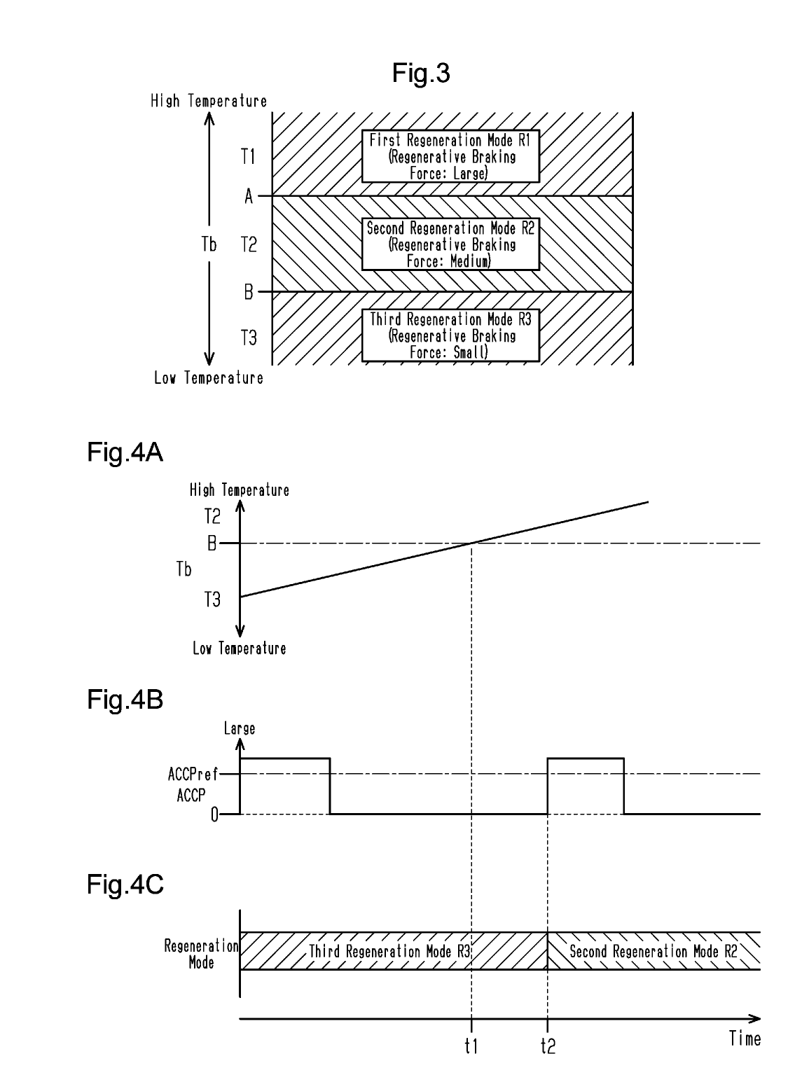

As shown in FIG. 3, in the present embodiment, the first regeneration mode R1, a second regeneration mode R2, and a third regeneration mode R3 are set as the regeneration modes. In the first regeneration mode R1, the regenerative braking force is the largest compared with the other modes. In the third regeneration mode R3, the regenerative braking force is the smallest as compared with the other modes. In the second regeneration mode R2, the regenerative braking force is smaller than that in the first regeneration mode R1, and larger than that in the third regeneration mode R3. That is, in the second regeneration mode R2, the regenerative braking force is medium as compared with the other modes. When they are arranged in order of magnitude in the regenerative braking force, third regeneration mode R3 < second regeneration mode R2 < first regeneration mode R1.

In the process of S120, when determining that the temperature region to which the acquired battery temperature Tb belongs is not the first temperature region T1 (S120: NO), the processing circuitry 110 executes the process of S160.

In the process of S160, the processing circuitry 110 determines whether the temperature region to which the acquired battery temperature Tb belongs is the second temperature region T2. When determining that the temperature region is the second temperature region T2 (S160: YES), the processing circuitry 110 acquires the current accelerator operation amount ACCP (S170).

After executing the process of S170, the processing circuitry 110 determines whether the acquired accelerator operation amount ACCP is greater than or equal to the accelerator determination value ACCPref (S180). The process of S180 is the same as the process of S140 described above.

In the process of S180, when determining that the accelerator operation amount ACCP is greater than or equal to the accelerator determination value ACCPref (S180: YES), the processing circuitry 110 selects the second regeneration mode R2 as the regeneration mode (S190).

In the process of S160, when determining that the temperature region to which the acquired battery temperature Tb belongs is not the second temperature region T2 (S160: NO), the processing circuitry 110 acquires the current accelerator operation amount ACCP (S200).

After executing the process of S200, the processing circuitry 110 determines whether the acquired accelerator operation amount ACCP is greater than or equal to the accelerator determination value ACCPref (S210). The process of S210 is the same as the process of S140 described above.

In the process of S210, when determining that the accelerator operation amount ACCP is greater than or equal to the accelerator determination value ACCPref (S210: YES), the processing circuitry 110 selects the third regeneration mode R3 as the regeneration mode (S220).

When any one of the processes of S150, S190, and S220 is completed or when a negative determination is made in any one of the processes of S110, S140, S180, and S210, the processing circuitry 110 ends the present processes in the current execution cycle.

### Operation of the Present Embodiment

FIGS. 4A to 4C illustrate an example related to switching of the regeneration mode. FIG. 4A is a timing diagram illustrating changes in the battery temperature. FIG. 4B illustrates changes in the accelerator operation amount. FIG. 4C illustrates changes in the regeneration mode. In the example illustrated in FIGS. 4A to 4C, the battery temperature Tb before time t1 belongs to the third temperature region T3 less than or equal to the second predetermined value B.

As shown in FIGS. 4A to 4C, before time t1, when the battery temperature Tb belongs to the third temperature region T3, the third regeneration mode R3 is selected as the regeneration mode. The third temperature region T3 has the lowest temperature. The regenerative braking force in the third regeneration mode R3 is the smallest. Therefore, when the accelerator operation amount ACCP becomes 0 due to the accelerator-off operation, the regenerative braking force by the third regeneration mode R3 is generated in the second MG 320.

When the battery temperature Tb gradually increases and thus exceeds the second predetermined value B at time t1, the battery temperature Tb belongs to the second temperature region T2. Accordingly, an affirmative determination is made in the process of S160. However, when the accelerator operation amount ACCP is 0 at time t1, that is, when the accelerator is off, a negative determination is made in the process of S180. Thus, since the regeneration mode is not switched, the third regeneration mode R3 is maintained for a certain period after time t1.

Thereafter, at time t2, when the accelerator operation amount ACCP increases from 0 and becomes greater than or equal to the accelerator determination value ACCPref, an affirmative determination is made in the process of S180. Accordingly, the second regeneration mode R2 is selected as the regeneration mode. In other words, the regeneration mode is switched. After the regeneration mode is switched to the second regeneration mode R2, when the accelerator operation amount ACCP becomes 0 due to the accelerator-off operation, the regenerative braking force by the second MG 320 is generated in the second regeneration mode R2. Therefore, a larger regenerative braking force is generated than when the third regeneration mode R3 is selected as the regeneration mode.

### Advantages of the Present Embodiment

(1) As the battery temperature Tb is lower, the allowable charging power Win is changed to a smaller value. The controller 100 controls the charging power of the battery 250 so as not to exceed the allowable charging power Win. The controller 100 includes the processing circuitry 110.

When the battery temperature Tb is relatively low, the processing circuitry adjusts the regenerative braking force such that the regenerative braking force is smaller when the battery temperature Tb is relatively low than when the battery temperature Tb is relatively high. For example, in FIGS. 4B to 4C, the processing circuitry 110 adjusts the regenerative braking force such that the regenerative braking force applied when the battery temperature Tb is relatively low is smaller than the regenerative braking force applied when the battery temperature Tb is relatively high. For example, the regenerative braking force is adjusted such that the regenerative braking force in the third temperature region T3 and the third regeneration mode R3 is smaller than the regenerative braking force in the second temperature region T2 and the second regeneration mode R2. The regenerative braking force is generated in the second MG 320 when the accelerator is off in the vehicle 500.

Accordingly, the lower the battery temperature Tb and the smaller the allowable charging power Win, the smaller the regenerative braking force. This reduces the power generation amount of the second MG 320. When the amount of power generated by the second MG 320 decreases, the power supplied to the battery 250 decreases. Thus, for example, even if the process of starting the internal combustion engine 10 by driving the first MG 310 is not performed, the charging power of the battery 250 is reduced in the present embodiment. Consequently, the start of the internal combustion engine 10 is limited when the temperature of the battery 250 is relatively low.

(2) A plurality of temperature regions (T1 to T3) are set for the battery temperature Tb. The regenerative braking force (T1 to T3) is set for each of the temperature regions (R1 to R3).

Thus, for example, as compared with when the regenerative braking force is set for each battery temperature Tb without setting such a temperature region, the present embodiment simplifies the adaptation between the battery temperature Tb and the regenerative braking force. Further, for example, a smaller calculation load occurs when the regenerative braking force is set.

(3) If the regenerative braking force changes due to a change in the temperature of the battery 250 while the regenerative braking force is being generated by the accelerator-off operation, the driver of the vehicle 500 may feel a sense of discomfort. For example, in FIG. 4C, when the regenerative braking force is switched to the regenerative braking force of the third regeneration mode R3 at time t1 while the regenerative braking force of the second regeneration mode R2 is being generated, a sense of discomfort may occur. In the present embodiment, the regenerative braking force is changed in accordance with a temperature change in the battery 250 after the accelerator pedal is depressed by the driver in the vehicle 500 (S140; S180; S210: YES, t2). For example, in FIG. 4C, the second regeneration mode R2 is switched to the third regeneration mode R3 at time t2 at which no regenerative braking force is generated due to an increase in the accelerator operation amount ACCP. That is, when an affirmative determination is made in any of the processes of S140, S180, and S210 in FIG. 2, the selection of the regeneration mode (S150; S190; S220) is performed.

Accordingly, in the present embodiment, while the regenerative braking force is being generated by the accelerator-off, the change of the regenerative braking force due to the temperature change in the battery 250 is not performed. When the accelerator is turned off next time, the changed regenerative braking force is obtained. For example, in FIG. 4C, when the accelerator is turned off after time t2, the regenerative braking force of the changed third regeneration mode R3 is obtained. This allows the present embodiment to limit situations in which the driver feels a sense of discomfort as described above.

### Modifications

The present embodiment can be modified and implemented as follows. The present embodiment and the following modification examples can be implemented in combination with each other to the extent that they do not contradict each other technically.

The number of temperature regions of the battery temperature Tb may be changed.

The number of regeneration modes may be changed.

The regenerative braking force may be set for each battery temperature Tb without setting the temperature region of the battery temperature Tb. Even in this case, the advantages other than (2) are gained.

The processes of S130 to S140, S170 to S180, and S200 to S210 shown in FIG. 2 may be omitted. That is, when an affirmative determination is made in the process of S120, the process of S150 may be executed. When an affirmative determination is made in the process of S160, the process of S190 may be executed. When a negative determination is made in the process of S160, the process of S220 may be executed. Even in this case, the advantages other than (3) are gained.

A case where a traveling mode in which the regenerative braking force is larger than the regenerative braking force during normal traveling is prepared in the vehicle 500 will now be described. Even when such a regenerative braking force increasing mode is selected, the above-described adjustment of the regenerative braking force may be performed. Examples of the regenerative braking force increasing mode include a sport mode, a power mode, and an S-range mode. In the sport mode or the power mode, the motion performance of the vehicle 500 is increased to be higher than the motion performance at the normal time. In the S-range mode, a shift pattern of a transmission provided in a drive system of the vehicle is set to a pattern suitable for sport traveling.

The controller 100 is not limited to a device that includes a CPU and a memory module and executes software processing. For example, in the above-described embodiment, the controller 100 may include dedicated hardware circuits, such as an application-specific integrated circuit (ASIC), for executing at least part of the processes performed by software. That is, the controller 100 may be modified as long as it includes processing circuitry that has any one of the following configurations (a) to (c): (a) processing circuitry including one or more processing devices that execute all of the above processes in accordance with a program or program code, and one or more program storage devices such as a ROM or a program product that stores the program or the program code; (b) processing circuitry including one or a plurality of processing devices and one or a plurality of program storage devices or program products that execute a part of the processing according to a program, and one or a plurality of dedicated hardware circuits that execute the remaining processing; and (c) processing circuitry including one or more dedicated hardware circuits that execute all of the above-described processes. The program storage device, which is a non-transitory computer-readable storage medium, includes any type of medium that is accessible by general-purpose computers or dedicated computers.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A controller for a vehicle, the controller comprising processing circuitry configured to:
control a charging power of a battery of the vehicle, wherein
the battery is configured to transmit and receive power to and from a first motor generator and a second motor generator of the vehicle, the first motor generator is connected to a sun gear of a planetary gear mechanism including the sun gear, a ring gear, and a carrier, a crankshaft of an internal combustion engine of the vehicle is connected to the carrier, the second motor generator is connected to the ring gear, a drive wheel of the vehicle is connected to the ring gear, the battery has an allowable charging power, a value of the allowable charging power is changed to a smaller value as a battery temperature of the battery is lower, and the processing circuitry configured to control the charging power of the battery such that the charging power does not exceed the allowable charging power; and
adjust a regenerative braking force generated by the second motor generator when an accelerator of the vehicle is off, wherein the processing circuitry configured to adjust the regenerative braking force such that the regenerative braking force applied when the battery temperature is relatively low is smaller than the regenerative braking force applied when the battery temperature is relatively high.

2. The controller for the vehicle according to claim 1, wherein
multiple temperature regions are set for the battery temperature, and
the processing circuitry is configured to select, as the regenerative braking force, one of multiple regenerative braking forces respectively set for the temperature regions.

3. The controller for the vehicle according to claim 1, wherein
the processing circuitry is configured to change the regenerative braking force in accordance with a temperature change in the battery after an accelerator pedal of the vehicle is depressed by a driver of the vehicle.

4. A vehicle, comprising:
a planetary gear mechanism including a sun gear, a ring gear, and a carrier;
a first motor generator connected to the sun gear;
an internal combustion engine including a crankshaft connected to the carrier;
a second motor generator connected to the ring gear, wherein a regenerative braking force is generated in the second motor generator when an accelerator of the vehicle is off;
a drive wheel connected to the ring gear;
a battery that transmits and receives power to and from the first motor generator and the second motor generator, wherein the battery has an allowable charging power, and a value of the allowable charging power is changed to a smaller value as a battery temperature of the battery is lower; and
a controller including processing circuitry configured to control a charging power of the battery so as not to exceed the allowable charging power, wherein the processing circuitry is configured to adjust the regenerative braking force such that the regenerative braking force applied when the battery temperature is relatively low is smaller than the regenerative braking force applied when the battery temperature is relatively high.
